(19) United States
(12) Patent Application Publication
(10) Pub. No.: US 2010/0011435 A1
(43) Pub. Date: Jan. 14, 2010

(54) Method and System for Providing Guaranteed File Transfer in Corporate Environment Behind Firewall

(75) Inventors: Raymond Soon Siew Wee, Singapore (SG); Gusniawan Kurniadi, Singapore (SG); Adrianus Voldi Sinarta, Singapore (SG)

Correspondence Address: ASP Works PTE LTD, Block 16 Kallang Place Unit #07-26/27, Kallang Basin Industrial Estate, Singapore, 339156, SG

(73) Assignee: ASP WORKS PTE LTD, Singapore (SG)

(21) Appl. No.: 12/498,344

(22) Filed: Jul. 6, 2009

Related U.S. Application Data
(60) Provisional application No. 61/078,776, filed on Jul. 8, 2008.

(51) Int. Cl. H04L 9/32; G06F 15/16

(52) U.S. Cl. 726/15; 709/206

(57) ABSTRACT

A method, system, and computer program for transferring a file or a a text message from a user to one or more recipients in a network. The method includes routing the data packet from the sending user to one or more recipients behind a firewall. The method includes segmenting a file into a series of file blocks. The method includes compressing and encrypting the file blocks. The method includes verifying the integrity of each file block. The method includes a self recovery process that comprises means for maintaining the current state of the transfer, means for resuming interrupted transfer automatically, and means for checkpoint restart. The method includes store and forward technique where the file is kept in the intermediate server and it is sent at a later time to the recipient.

### CROSS-REFERENCE TO RELATED APPLICATIONS

This application claims the benefit of provisional patent application Ser. No. 61/078,776, filed Jul. 8, 2008 by the present inventors.

### FEDERALLY SPONSORED RESEARCH

Not Applicable

### SEQUENCE LISTING OR PROGRAM

Not Applicable

### BACKGROUND

1. Field of Invention

This invention relates to the field of networking, specifically to a method, a system, and a computer program for guaranteed delivery of files through a network behind firewall.

2. Description of Prior Art

File transfer is a common mechanism to send file or document across private network and Internet to form collaboration between business partners.

Originally FTP and email are used for file exchange in business environment. However, there are two major drawbacks with file transfer using FTP and email. The first drawback is that FTP and email are not secure. FTP application transmits user credentials and files in clear through a network. Email has limitation pertaining to file transfer. The file has to be attached in the email, which only certain maximum file size is allowed, and the attached file is not encrypted.

The second drawback is that FTP and email are not reliable. FTP and email protocol are not designed to transmit large file to the recipient. If the file sent by an FTP client is corrupted, there is no auto-retry and checkpoint restart mechanism to recover the transmission. In the event of failure, the file has to be retransmitted from the beginning.

Thereafter, inventors created several systems to transfer files through a network in such a way as the file was encrypted before the file transfer takes place. U.S. patent 2008/0016239 A1 to Miller et al. (2008), U.S. Pat. No. 5,297,208 to Schlafly et al. (1994) disclose a system which secures and transfers a file from a sending user to one or more receiver users in a network; however, the system doesn't perform checkpointing at specified intervals. The purpose of checkpointing is to minimize the amount of time and effort wasted when a long file transfer is interrupted by a hardware failure, a software failure, or network connection unavailability. With checkpointing, the file transfer can be restarted from the latest checkpoint rather than from the beginning.

Another system has been proposed—for example, U.S. Pat. No. 6,512,763 B1 to DeGolia, Jr. (2003) and U.S. Pat. No. 6,978,378 B1 to Koretz (2005). Although it is capable to send files to a destination server through intermediate stations, the system doesn't perform checkpoint restart for file transfer recovery. U.S. Pat. No. 5,734,820 to Howard et al. (1998) discloses a complex data communication system that includes communication module, a control module, a mailbox module, an auto connect module, a log module, and an exits module. Although it reduces problems associated with security in data communication by implementing hub-and-spoke architecture and limiting the access to the data repository, it uses standard network protocols such as FTP, HTTP, Async, and Bisync to transmit a file over a network. Thus, when the file transfer is interrupted, the only way to recover the file transfer is by sending the whole file again. Further, the system is designed based on hub-and-spoke architecture where centralized hub accepts requests from multiple applications that are connected to the centralized hub as spokes, to grow a community of trading partners and customers, so it is not suitable for small and medium businesses use.

All the system heretofore known suffer from a number of disadvantages:

(a) In FTP and the above patents, a file being transmitted is divided into many file blocks. After a portion of the file blocks has been received by the receiving user, the transmission process may be aborted for various reasons. Although it can recover the aborted file transmission by sending the whole file again, it will be wasteful of resources, especially when the file size is large and it is transmitted over public Internet.

(b) In FTP, user name and password is transmitted in clear during login. File is transmitted in clear as well. That means, someone is able to eavesdrop sensitive information and potentially security is compromised.

(c) Because FTP is a port-hopping protocol (i.e. data channels use a random port chosen during the communication), many firewalls have the ability to understand the FTP protocol and allow the secondary data connections. If the control connection is encrypted using TLS/SSL (or any other method for that matter) the firewall is not able to get the port numbers of the data connections from the control connection (since it is encrypted and the firewall cannot decrypt it). Therefore in many firewalled networks clear FTP connections will work while FTPS connections will either completely fail or require the use of passive mode.

(d) FTP and email don't have audit capability.

(e) FTP and the above patents do support store and forward capability, which means the sending user is able to transfer a file to intermediate server so one or more users receive the file at a later time. However, they use only one intermediate server, which leads to single point of failure.

### SUMMARY

In accordance with the present invention a method, a system, and a computer program comprises multiple transfer nodes operable to transfer and retrieve files securely with checkpoint restart, collaboration servers operable to manage data flow between transfer nodes, and multiple transfer storage associated with a particular transfer node to store and forward files to destination.

### OBJECTS AND ADVANTAGES

In light of foregoing discussion, there exists a need for a method and a system that provides guaranteed delivery of file transfer from the sending user to the one or more receiving users.

Several objects and advantages of the present invention are:

(a) to allow the user to send a file to one or more users in a network that can be geographically constrained or global, wired or wireless, for example, a Local Area Network (LAN) or a Wide Area Network (WAN), such as the Internet. The network connection type can be leased line, a Virtual Private Network (VPN), a dial up connection, or broadband connection with static IP or dynamic IP.

(b) to allow the user to send a file to one or more offline users, who can then receive the file at a later time.

(c) to allow the user to send a file to one or more users regardless of device or operating system use. The users can retrieve the file from a desktop, laptop, or mobile device; and on Windows, Linux, Unix, and Mac OS X; and regardless of the setting of the incoming port of the firewall.

(d) to perform check point restart for recovering the file transfer and to ensure the integrity of the file.

(e) to track and monitor the progress of the file sent and received.

(f) to assign transfer rights from a sending user to one or more receiving users.

Further objects and advantages are to provide a system which is cost effective for small and medium businesses (SMB) and large enterprises and which can be used and implemented by a user with limited IT skills.

Still further objects and advantages will become apparent from a consideration of the ensuing description and drawings.

### DRAWING FIGURES

The preferred embodiments of the present invention will hereinafter be described in conjunction with the appended drawings provided to illustrate and not to limit the invention, wherein like designations denote like elements, and in which:

FIG. 1 is a block diagram of an exemplary network that shows various embodiments in a network that can be applied in the present invention.

FIG. 2 is a block diagram of a system for transferring a file from a sending user to one or more receiving users in a network, in accordance with another embodiment of the present invention.

FIG. 3 is a diagram of routing of file transfer from a sending user to one or more receiving users in a network, in accordance with the present invention.

FIG. 4 is a diagram of a message format for transferring file block in accordance with the present invention.

FIG. 5 is a diagram illustrating a method of file retransmission in the event the network disrupted in accordance with the present invention.

FIG. 6 is a diagram illustrating a method for storing a file temporarily to be sent to the at least one receiving users at a later time in accordance with the present invention.

FIG. 7 is a flowchart, illustrating the detailed steps for transferring a file from a sending user to one or more receiving users in a network, in accordance with the present invention.

### DESCRIPTION

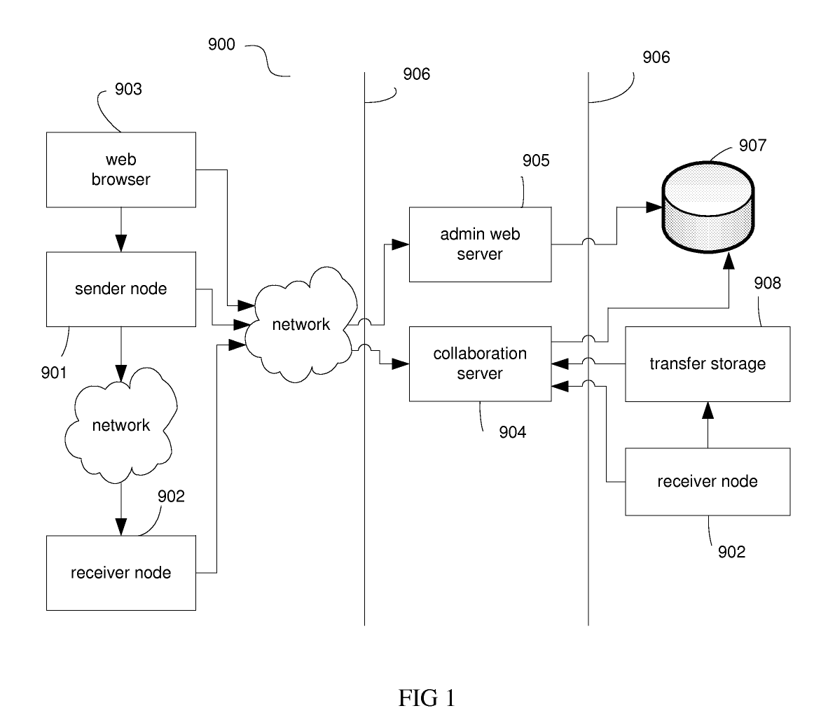

Referring first to FIG. 1, there is shown a computer network 900 in accordance with the present invention. Network 900 includes collaboration server 904 and database server 907, sender node 901, receiver node 902, and transfer storage 908 across network connection 900. In this present invention, the network connection 900 is the Internet, intranets, local area networks (LANs), broadband, dial-up, or any TCP/IP based network connection to which the sender node 901, receiver node 902, transfer storage 908, and the collaboration server 904 are connected. User uses web browser 903 to browse the admin web site that is hosted in admin web server 905.

Sender node 901 and receiver node 902 are the system used by the end user to send and receive files. It has web-based UI and its UI is intuitive so non IT person can use the software without training.

The collaboration server 904 allows sender node 901 and receiver node 902 to transmit at least one file and text messages through the network 900 conforming to a predetermined protocol. The collaboration server 904 stores the IP address and port number belongs to sender node 901 and receiver node 902. Further, collaboration server 904 maintains persistent connection, and it routes the data transfer, so the sending user can send file to the one or more receiving users even the receiving user is blocked by firewall. All communications from collaboration server 904 to sender node 901, receiver node 902, and transfer storage 908 are encrypted.

The transfer storage 908 is a temporary remote storage that allows the sending user to send a file to the one or more receiving users anytime regardless whether the receiving user is online. Transfer storage 1008 resides in either data center or corporate premises to keep the files temporarily until the recipient pulls the file from the transfer storage 1008. It can also keep the files permanently if the file must be retained for audit.

In order for the sending user to establish connection to the receiving user, the incoming port of the receiving user's firewall 906 must be opened. The receiving user needs only one incoming TCP port to be opened so the connection can be established from the sending user to the receiving user.

If the incoming port of the firewall 906 of the receiving user is closed, the sender node 901 sends a file through the collaboration server 904. The sender node 901 sends file directly to the receiver node 902 if the firewall's incoming port of the receiver node 902 is opened.

The file transfer will take place if the following conditions are met.

a. the data packet is allowed to pass through the collaboration server 904; or

b. the incoming port of firewall 906 is open so the data packet can go direct to the receiving user.

Transfer storage 908 receives file on the receiving user's behalf. After the file transfer is completed, the receiver node 902 will pull the file from the transfer storage 1008.

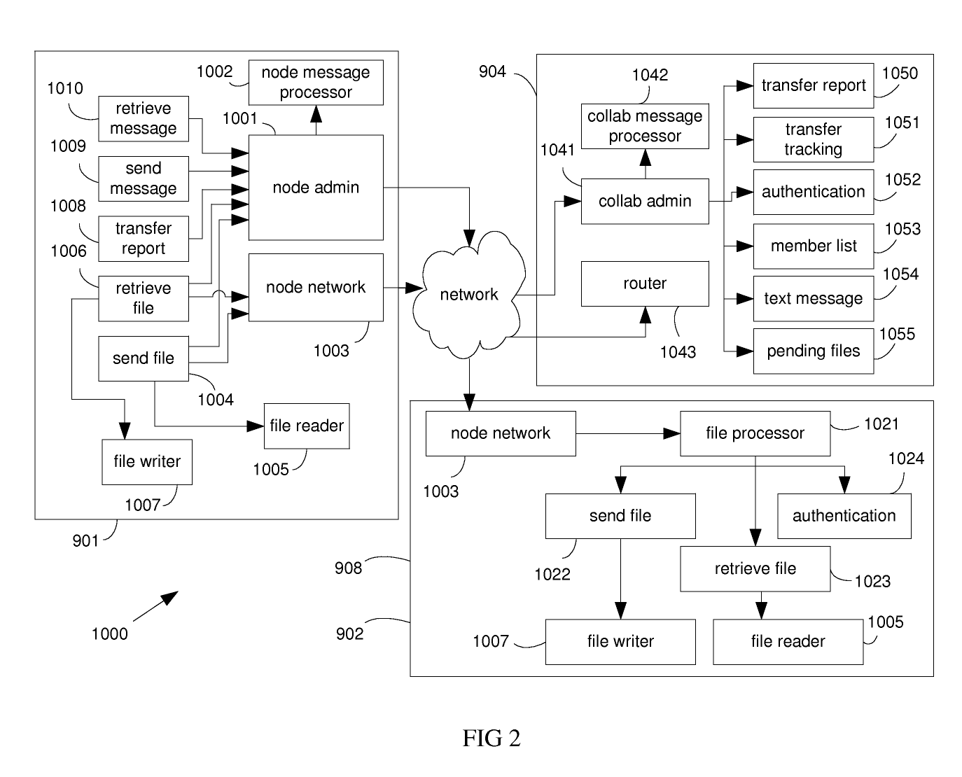

FIG. 2 is block diagram, illustrating various modules for transferring a file from a sender node 901 to receiver nodes 902 and transfer storage 908 in network 900, in accordance with an embodiment of the present invention.

Send file module 1004 sends the file to one or more receiver nodes 902. Subsequently, node network module 1003 establishes the network connection to the collaboration server 904, receiver node 902, or transfer storage 908.

Send file module 1004 uses file reader module 1005 to open and read source file. File reader module 1005 is responsible to keep track the file pointer as well, compress file block on the fly, encrypt file block on the file, and calculate the file block checksum.

Send file module 1004 and, retrieve file module 1006, transfer report module 1008, send message module 1009, and retrieve message module 1010 use node admin module 1001 to send admin messages to the collaboration server 904. Node admin module 1001 uses node message processor 1002 to encrypt the admin messages before it is sent through network 900. Node admin module 1001 is a Java-based XML RPC client.

Retrieve file module 1007 will retrieve one or more files that are stored in the transfer storage 908. Retrieve file module 1007 uses file reader module 1005 to write the file block to a temporary file on the disk. File reader module 1005 is responsible to create unique file name based on date/time stamp and sender ID. After the process of file retrieval is completed, the retrieve file module 1007 will move the temporary file to the pre-assigned destination folder.

In the collaboration server 904, router module 1043 is responsible for the data routing.

Collab admin module 1041 serves administrative request from sender node 901. The administrative message is encrypted and it will be decrypted by collab message processor module 1042. The admin request will go to the respective modules, i.e. transfer report module 1050, transfer tracking module 1051, authentication module 1052, member list module 1053, text message module 1054, and pending files module 1055.

Receiver node 902 and transfer storage 908 comprise node network module 1003, file processor module 1021, send file module 1022, retrieve file module 1023, and authentication module 1024.

System 1000 is implemented using Java SE 5 and it can run on any platform by using standard operating system (OS) such as Microsoft Windows, Linux, Unix, and Apple Mac OS X. System 1000 can use databases 907 such as MySQL, Oracle, Apache Derby, Microsoft SQL Server, and other databases.

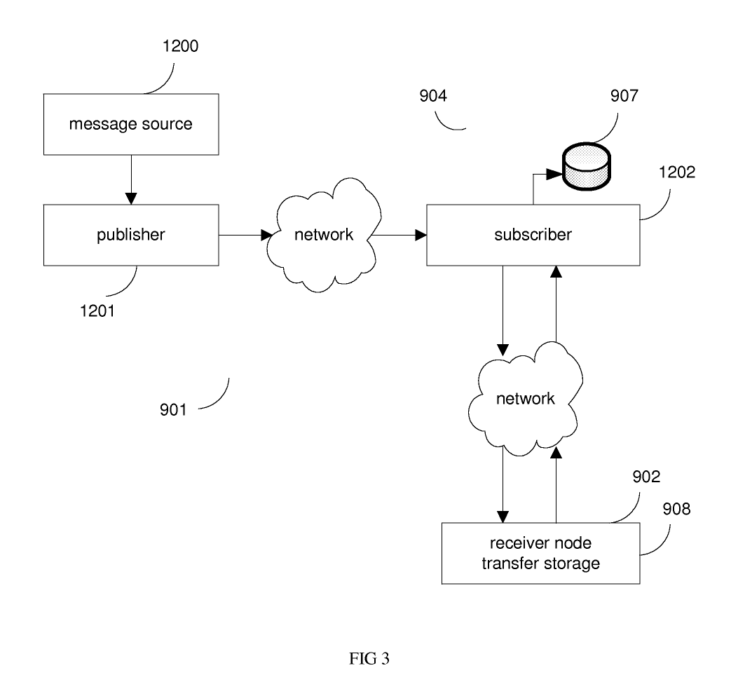

FIG. 3 is a block diagram, illustrating a system for routing data packet in a network.

Message source object 1200 creates messages, including FT Connect message 1305, FT Sync message 1307, FT Data message 1309, and FT Close message 1311, and passes them to publisher objects 1201.

Publisher object 1201 receives a message from a message source object 1200 and it tries to deliver it to all of the subscriber objects 1202 that have registered with the publisher object 1201 to receive messages. The delivery mechanism is implemented to allow messages to be delivered through the Internet.

Subsequently, subscriber object 1202 is responsible for receiving messages from publisher objects 1201 on behalf of receiver node 902 and transfer storage 908.

Further, receiver node 902 and transfer storage 908 is responsible for registering to receive messages. Receiver node 902 and transfer storage 908 communicates their interest in receiving messages by registering message types with the subscriber object 1202. The message type includes new file notification and new text message notification.

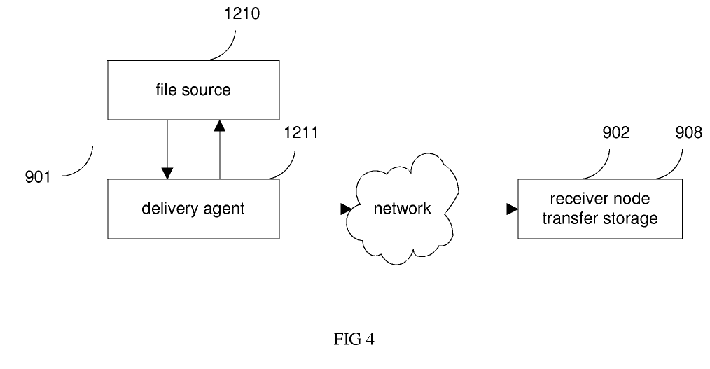

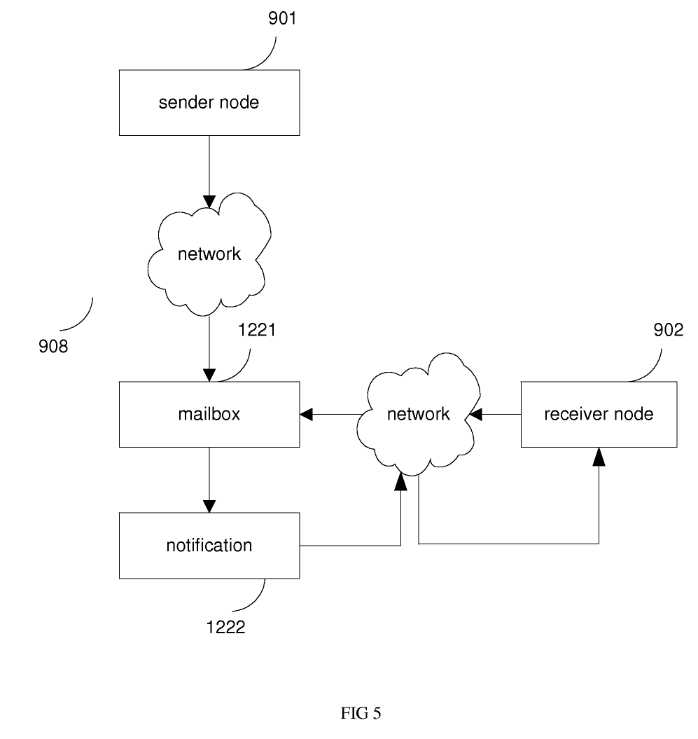

FIG. 4 is a block diagram, illustrating a method and a system for retransmission of data block.

The system needs to ensure that the sender node 901 can reliably send a file to a receiver node 902 and transfer storage 908.

File source object 1210 has responsibility to open the source file, read blocks of the source file, compress the file blocks, encrypt the file blocks, calculate checksum of the file blocks, and pass them to delivery agent object 1211. File source object 1210 also calculates the checksum of the checkpoint block.

Delivery agent object 1211 delivers the file block to the receiver node 902 and transfer storage 908. If its first attempt to deliver the file block fails, it keeps repeating the attempt until it succeeds. Delivery agent object 1211 also ensures that the file blocks are delivered successfully and retransmit the file block if the file block is corrupted during delivery process.

The file block is delivered exactly once. To be certain that a delivery attempt succeeded is to have the receiver node 902 and transfer storage 908 send an acknowledgement back to the delivery agent object 1211 when it receives a message.

To ensure that file delivery will continue if there is a crash, the delivery agent object 1211 stores the record of waiting file blocks on disk.

Further, the delivery agent object 1211 measures the time from sending a file block until it receives the acknowledgement back from receiver node 902 and transfer storage 908. Subsequently it calculates the network bandwidth and provides feedback to the file source object 1210 so file source 1210 can adjust the file block size to speed up or slow down the file transfer.

The system will automatically restart the delivery agent object 1211 after a crash, so it resumes the pending file transfer. In that case, the delivery agent object 1211 will get last checkpoint block checksum from the file source object 1210 and it sends the last checkpoint block checksum to receiver node 902 and transfer storage 908. If the integrity of the last checkpoint block is verified, the file transfer will continue from the last checkpoint. If it is corrupted, the delivery agent object 1211 will instruct the file source object 1210 to reset the file pointer to the previous calculated checkpoint.

FIG. 5 is a block diagram, illustrating a system for mailbox for store and forward that provides reliable delivery of file to recipients.

Store and forward is a technique in which file is sent to a transfer storage 908 where it is kept and sent at a later time to the one or more receiving users. The transfer storage 908 verifies the integrity of the file before forwarding it. This technique is used in networks with intermittent connectivity, especially in the wilderness or environments requiring high mobility. It is also used when there are long delays in transmission and variable and high error rates, or if a direct, end-to-end connection is not available.

The other benefit of transfer storage 908 is to minimize the resources required to send a file to multiple receiving users. The file is delivered only once to the transfer storage 908 and subsequently the transfer storage 908 will distribute the file to at least one or more receiving users.

Sender node 901 sends the file to transfer storage 908.

Mailbox object 1221 is responsible for storing file until one or more receiver node 902 polls for them.

Transfer storage 908 maintains a collection of mailbox objects 1221. Each mailbox object 1221 is associated with a receiver node 902. Each mailbox object 1221 collects files associated with the receiver ID.

Notification object 1222 sends a message to at least one or more receiver nodes 902 if the receiver 902 is online. It also sends an email notification to a registered email address associated with the receiving user of receiver node 902. Subsequently, receiver node 902 polls files from transfer storage 908.

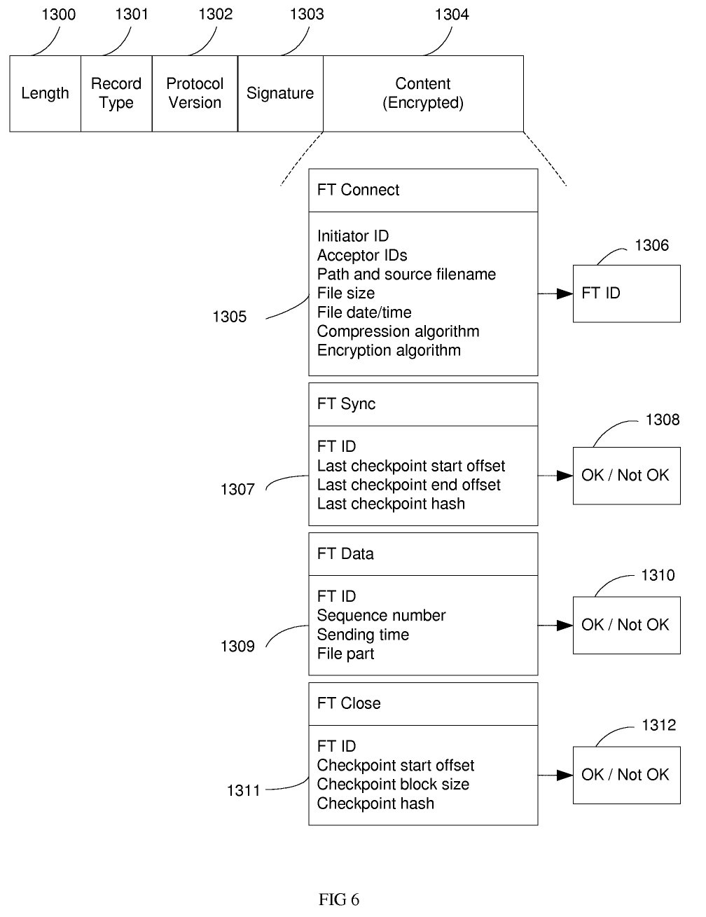

FIG. 6 shows file transfer message format in accordance with an embodiment of the present invention.

The FT connect message 1305 establishes a connection involves two operations: creation of communication level link and authentication/acceptance of the sending user by the receiving user.

The FT sync message 1307 enables the sender node 901 and receiver node 902 and transfer storage 908 to synchronize file transfer before sending new message. A comparison of checksum of last checkpoint block will indicate any corruption or gap. If the file is corrupted, the receiving user will return the last good checkpoint and the sending user then will reset the pointer to the last good checkpoint. The sender node 901 will transfer the file from the last good checkpoint.

The FTP data message 1309 contains file block to be sent to the receiving user. The data message consists of 8 fields that are separated by start of heading <SOH> character to mark a non-data section of a data stream.

The sender node 901 will send a synchronize message at every checkpoint block size. The message will contain checkpoint number, block size, and checksum of the block. The receiving user will check the checksum of the destination file and compare it with the checksum sent by the sending user. If both values are the same, the data transfer will continue on. If both values are not the same, which indicates file corruption, the receiving user will reset the file pointer to the last good checkpoint.

After the last file block is transferred, the sender node 901 will issue an FT close message 1311 to close the file transfer and terminate the connection. The receiver node 902 and transfer storage 908 will do the necessary post-processing tasks to the file.

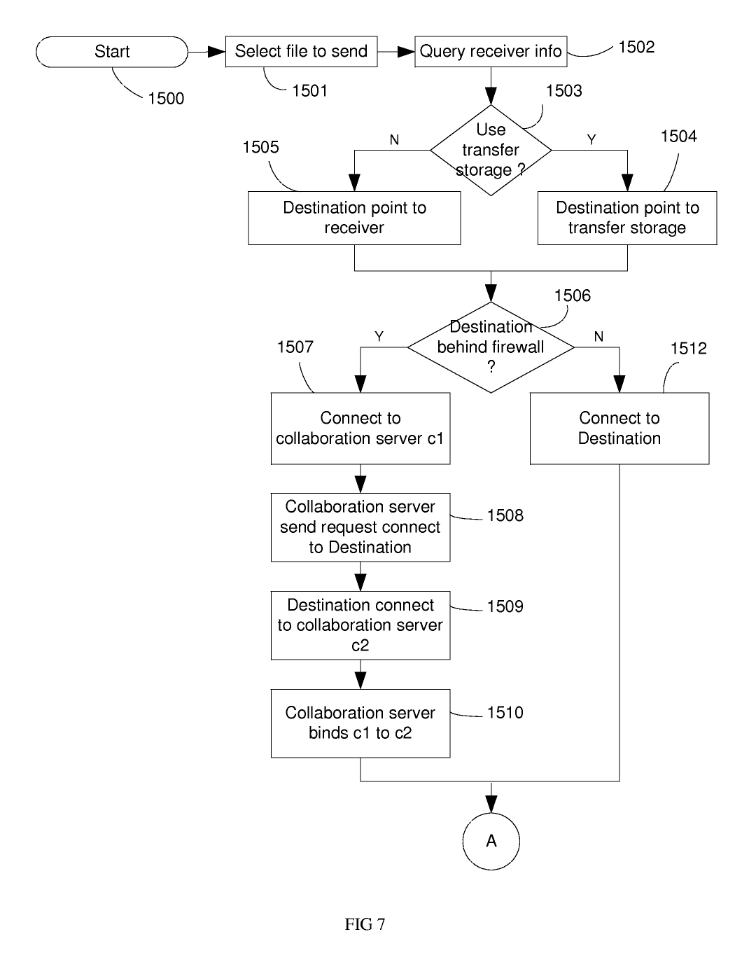

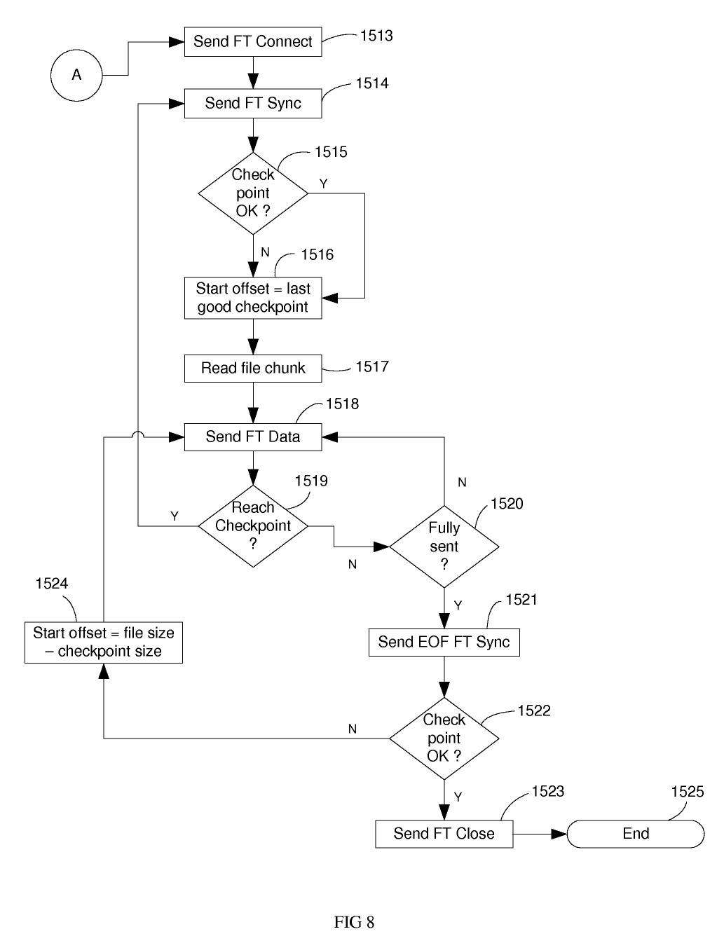

FIG. 7 is a flowchart, illustrating a method for sending files from a sender node 901 to at least one or more receiver nodes 902 in accordance with an embodiment of the present invention.

Firstly, the sending user selects the receiving users and files to be sent. After the user instructs the system to send the file, the system will authenticate the sending user and the receiving user. The system will then follow the steps below:

(a) The system sends the file as a series of data blocks.

(b) Each file block is compressed and encrypted on the fly.

(c) Check if the receiving user is behind firewall and the incoming port of the receiving user is blocked.

(d) Check if it requires store and forward.

(d) If it requires store and forward, the file will be sent to transfer storage and it is stored temporarily until the receiving user in connected to the system and receives the files.

(e) If the receiving user is behind firewall, the sending user will establish network connection to the collaboration server.

At step 1501, one or more files are selected to be sent. At step 1502, the system will retrieve the receiver node data from the collaboration server 904. The receiver node data contains receiver node 902 IP address, receiver node 902 incoming port number, transfer storage 908 ID, and firewall status. At step 1503, the system checks whether transfer storage 908 should be used. If transfer storage 908 is used, the system will set transfer storage 908 as destination at step 1504. Otherwise, the system will set receiver node 902 as destination at step 1505.

Transfer storage 908 ID is only returned if the receiving user account has store-and-forward feature so the file transfer can take place even the receiving user is offline. If the receiving user supports store-and-forward feature, the transfer will take place from sending user to transfer storage 908. Otherwise, the file will be sent directly to the receiver node 902.

At step 1506, the system checks whether it needs to send the file to the collaboration server 904 for routing. If the destination is blocked by firewall 906, the sender node 901 will establish network connection c1 to the collaboration server 904 at step 1507. Subsequently, at step 1508, the collaboration server 904 sends a connection request to the destination. The destination will establish network connection c2 to the collaboration server 904 at step 1509. At step 1510, the collaboration server 904 binds two network connections c1 and c2 so the data routing can take place. Subsequently, the sender node 901 will send data block to the collaboration server 904 through network connection c1. The collaboration server 904 will route the data block to the destination through network connection c2.

If the destination is not blocked by firewall 906, the sender node 901 will establish direct network connection to the destination at step 1512.

At step 1513, the sender node 901 sends FT connect message 1305 to the destination. After the destination returns FT ID 1306, the sender node sends FT sync message 1307 at step 1514. The destination will synchronize the last number of file block that has been sent by verifying the integrity of last checkpoint block. At step 1515, the system checks whether the last checkpoint block is OK. If it is not OK, the system will adjust the file pointer to the last good checkpoint at step 1516.

At step 1517, the sender node 901 read file chunk from the last file pointer. Then, it sends the FT data message 1309 to the destination at step 1518. At step 1519, the system checks whether it is time for performing a check point. It will goes back to step 1514 to send FT sync message 1307 to the destination. At step 1520, the system checks whether the file is fully sent to the destination. If it is fully sent, the sender node 901 sends the last FT sync message 1307. If the last checkpoint block is verified, the system will continue to step 1523, which sends FT close message 1311. If the last checkpoint block is corrupted, the system has to adjust the file pointer at step 1524 and resend the data.

The FT close message 1311 indicates that the end of file has been reached. It also contains the checksum of the file. The destination will return the status to the sender node 901 whether file is transferred successfully.

### CONCLUSION, RAMIFICATIONS, AND SCOPE

Accordingly, the reader will see that the system of this invention can be used to transfer file from a sending user to one or more receiving users securely and robust. In addition, the sending user can transfer any type of file without size limitation to personal computers, laptops, and mobile devices run on any operating system that supports Java 5 and above (Windows, Unix, Linux, Mac OS X, Symbian, Windows Mobile, Android, etc.) in a network (including broadband, leased line, and dial-up) regardless the location of the receiving users. Furthermore, the present invention has the additional advantages in that
it sends a file as a series of data block and it calculates the checksum of each block to verify the data block integrity;
it performs checkpointing which guarantees that the integrity of the file block is assured and it resumes the file transfer from the last successful block transferred until completion;
it compresses each file blocks before accelerating it to the recipient users;
the encryption of each file blocks ensures confidentiality;
it provides file transfer tracking and monitoring;
it provides file transfer report and file repository for audit purposes;
it keeps the transferred files in the central repository and the recipient has the sole rights to retrieve the files at any time;
it provides centralized file transfer rights management with web-based administration to manage the users, groups, and their transfer rights;
it provides store-and-forward capability so the user can send one or more files to the offline recipients;
it provides assured and secured text messaging between collaborating users;
it provides automatic notification via email and SMS when new file and message arrives in the receiving user's mailbox.

Although the description above contains many specificities, these should not be construed as limiting the scope of the invention but as merely providing illustrations of some of the presently preferred embodiments of this invention. For example, the system is able to transfer a file without any human intervention in the network by providing scheduled transfer and file polling. Also, the system is able to execute predefined script for back-end integration.

Thus the scope of the invention should be determined by the appended claims and their legal equivalents, rather than by the examples given.

What is claimed is:

1. A method for transferring a file from a user to recipients in a network comprising:
a. connecting a plurality of computers by a communications channel that is secured by any mode of conventional firewall,
b. digital handshaking between said computers to establish communications,
c. transferring said file as a series of data blocks preceded by header bytes to the at least one receiving user reliably and efficiently,
d. detecting transmission errors of said data blocks,
e. resending said data blocks in case of said transmission errors,
f. receiving said file and verifying integrity of said file,
g. sending said file to an intermediate server.

2. The method of claim 1, wherein the communication channel can be a Local Area Network (LAN), Wide Area Network (WAN), such as the Internet on leased line, broadband, dial up, and Virtual Private Network (VPN), with static IP or dynamic IP.

3. The method of claim 1, wherein the file can be any type of file, a document, an image, a text file, a binary file, a movie clip, an audio clip, and other file without size limitation.

4. The method of claim 1 further comprising the step of processing data block, wherein the step of processing the data block comprises the step of:
a. read and store a file chunk in array of bytes
b. compress the array of bytes of the file chunk
c. encrypt the array of bytes of the file chunk
d. calculate checksum of the array of bytes of the file chunk

5. The method of claim 1, wherein the step of ensuring the file arrives at the receiving users comprises the steps of:
a. the checksum of file block of sending user must match with the checksum of file block of receiving user.
b. the checksum of checkpoint block of sending user must match with the checksum of checkpoint block of receiving user.
c. the checksum of the entire file of sending user must match with the checksum of the entire file of receiving user.

6. The method of claim 5 further comprising the step of resubmitting the file block if the checksum of file block of sending user does not match with the checksum of file block of receiving user.

7. The method of claim 1 further comprising the step of tracking the submitted file.

8. The method of claim 1, wherein a file is sent to a receiving user that is set by a predefined access rights.

9. The method of claim 8, wherein the access rights are selected from a group consisting of rights to send said file, rights to receive said file, and rights to forward said file.

10. The method of claim 8, wherein the access rights assigned to the user are updated by the group owner.

11. The method of claim 1 further comprising the steps of storing an identity of the file, the identity being a unique identity of the file, such as filename, file size, and date time stamp.

12. The method of claim 1 further comprising the steps for monitoring file transfer:
a. recording the progress of bytes transferred from said sending user to said receiving user,
b. monitoring the network connection between said sending user and said receiving user,
c. reestablishing the network connection if the network connection between said sending user and said receiving user is disrupted,
d. resuming the file transfer automatically from said sending user to said receiving user after the network connection is reestablished.

13. The method of claim 1 further including establishing persistent network connection to server that is capable to route data blocks.

14. The method of claim 13 further including monitoring the persistent network connection and reestablishing the persistent network connection if said connection is disrupted.

15. The method of claim 1 further including sending a file to an intermediate server that is associated to one or more a receiving users.

16. The method of claim 15 further including sending the file from the intermediate server to the at least one receiving users at a later time.

17. The method of claim 1 further including sending a notification to the one of more receiver users after file is sent successfully.

18. The method of claim 17, wherein sending a notification comprises:
a. sending an email message to the receiving user,
b. sending data packet to said receiver user through persistent connection between said receiving user and server that is capable to route data blocks.

19. A method for routing data blocks from a sending user to a receiving user in a network, the method comprising:
a. authenticating the at least one user,
b. receiving said data blocks from said sending user,
c. sending said data blocks to a destination associated with said receiving users,

20. A computer program for transferring a file from a sending user to at least one receiving users in a network, the computer program comprising a computer readable medium comprising:
a. one or more instructions for submitting file as a series of data blocks preceded by header bytes to a receiving location.
b. one or more instructions for compressing the file block,
c. one or more instructions for encrypting the file block,
d. one or more instructions for creating an unique identity of the source file,
e. one or more instructions for storing the unique identity and attributes of the source file,
f. one or more instructions for generating an encryption key, the encryption key being used for encrypted the file,
g. one or more instructions for encrypting the file,
h. one or more instructions for sending the file to the at least one receiving user,
i. one or more instructions for authenticating the at least one receiving user,
j. one or more instructions for ensuring the file arrives at the receiving user,
k. one or more instructions for calculating checksum of the file block, checkpoint block, and the entire file,
l. one or more instructions for resubmitting the file block if the checksum of the file block does not match,
m. one or more instructions for sending the file to intermediate server,
n. one or more instructions for establishing a persistent connection between user and the server that is capable to route data blocks,
o. one or more instructions for the sending user to connect directly to the at least one receiving user if the receiving user connection is not blocked by firewall,
p. one or more instructions for the server to route data blocks of the file from a network connection of sending user to a network connection of receiving users if the receiving user connection is blocked by firewall,
q. one or more instructions for sending a text message from the sending user to the at least one receiving user.
